(19) United States
(12) Patent Application Publication
(10) Pub. No.: US 2025/0189687 A1
(43) Pub. Date: Jun. 12, 2025

(54) METHOD FOR SMOOTHLY COMBINING OVERLAPPING MISTIED STRUCTURAL DEPTH GRIDS

(71) Applicant: Saudi Arabian Oil Company, Dhahran (SA)

(72) Inventor: Simon A. Stewart, Dhahran (SA)

(21) Appl. No.: 18/536,465

(22) Filed: Dec. 12, 2023

(51) Int. Cl. G01V 1/30

(52) U.S. Cl. CPC G01V 1/301; G01V 2210/6161; G01V 2210/66

(57) ABSTRACT

Systems and methods include a computer-implemented method for generating a geological structure map from mistied grid patches. Information content is analyzed that is in each patch of mistied grid patches that overlap in an area of interest. Polygons that are defined by areas of overlap of the mistied grid patches are generated and slightly enlarged in the areas of overlap. The mistied grid patches are ranked based on information content criteria. Overlapping portions of the mistied grid patches are blanked based on the ranking, where top-ranked portions of the mistied grid patches remain unblanked. A geological structure map representing a single continuous subsurface geological layer in the area of interest is generated by combining unblanked portions of the mistied grid patches. Generating the geological structure map includes regridding the mistied grid patches and interpolating values between the unblanked portions of the mistied grid patches.

### TECHNICAL FIELD

The present disclosure applies to subsurface exploration geophysics.

### BACKGROUND

Subsurface mapmaking is used to create representations of geological formations for subsurface engineering applications, such as exploration for oil and gas, carbon dioxide (CO₂) sequestration, waste disposal, and the like. For example, maps can be used in the detailed site characterization for such applications. Mapmaking can include the use of, the interpretation of, and mapmaking from, reflection seismic data. For example, there may be multiple reflection seismic types or vintages in an area of interest.

### SUMMARY

The present disclosure describes techniques that can be used for smoothly combining overlapping mistied structural depth grids. In some implementations, a computer-implemented method includes the following. Information content is analyzed that is in each patch of mistied grid patches that overlap in an area of interest. Polygons that are defined by areas of overlap of the mistied grid patches are generated and slightly enlarged in the areas of overlap. The mistied grid patches are ranked based on information content criteria. Overlapping portions of the mistied grid patches are blanked based on the ranking, where top-ranked portions of the mistied grid patches remain unblanked. A geological structure map representing a single continuous subsurface geological layer in the area of interest is generated by combining unblanked portions of the mistied grid patches. Generating the geological structure map includes regridding the mistied grid patches and interpolating values between the unblanked portions of the mistied grid patches.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques can be used to solve the technical problem of how to combine map data from different mapped areas into a single continuous map without producing edge artifacts that normally result from combining maps from different sources and datasets. The map data can be combined while preserving (e.g., relying upon) the map patches having the highest fidelity to ensure the highest-quality final composite map. An information analysis algorithm can be used to prioritize overlapping map patches and support map combination processes. Composite maps can be made from various overlapping maps that do not themselves individually cover an entire area of interest. The techniques of the present disclosure can operate automatically and seamlessly, which can save time (e.g., user/mapmaker time). They can provide the added advantage of retaining the highest possible amount of structural information in a resulting composited map.

The techniques of the present disclosure eliminate misties in composited grids. Such misties typically need to be erased manually, such as using a completely manual grid manipulation workflow to cope with specific mistie scenarios. Further, the techniques of the present disclosure include the quantification of information content to guide the prioritization of patches in the compositing process. This can result in the automation of mapmaking, including improving speed and consistency, while providing an information prioritization element that typically does not exist in current systems. The techniques of the present disclosure can be used to cope with the wider problem of combining information in the form of map patches from different sources, such as different seismic volumes or even more disparate sources including maps made by hand from outcrops.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIGS. 1A-1D show patches associated with an area of interest, according to some implementations of the present disclosure.

FIG. 1E shows a combination of the patches with gaps filled in, according to some implementations of the present disclosure.

FIG. 2 is a flow chart showing an example of a workflow for combining map patches, according to some implementations of the present disclosure.

FIG. 3 is a graph which provides an information content comparison of map patches, according to some implementations of the present disclosure.

FIGS. 4A-4C collectively show an example of an implementation of prioritized overlap deletion and final regridding, according to some implementations of the present disclosure.

FIG. 5 is a flowchart showing an example of a method for combining mistied grid patches to generate a geological depth or structure map representing a single continuous subsurface geological layer in a given area of interest, according to some implementations of the present disclosure.

FIG. 6 illustrates hydrocarbon production operations that include both one or more field operations and one or more computational operations, which exchange information and control exploration for the production of hydrocarbons, according to some implementations of the present disclosure.

Like reference numbers and designations in the various drawings indicate like elements.

### DETAILED DESCRIPTION

The following detailed description describes techniques for automatically combining overlapping, mistied map patches to produce a geological depth or structure map that represents a single continuous subsurface geological layer in a given area of interest. This is done without producing edge effects that would normally result from combining mistied input grid patches. The techniques can use information content of ingredient patches to prioritize which patches are to take precedence in the compositing process in order to preserve information content in a resulting composited map.

Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

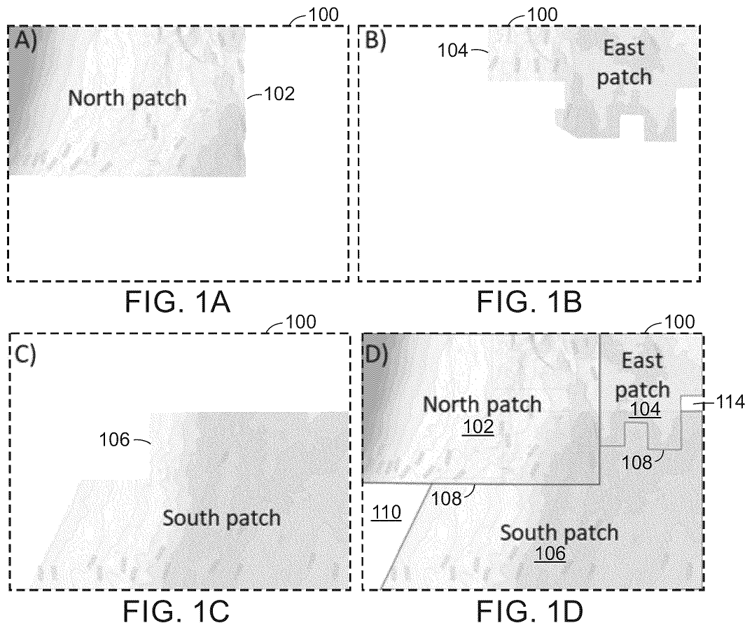

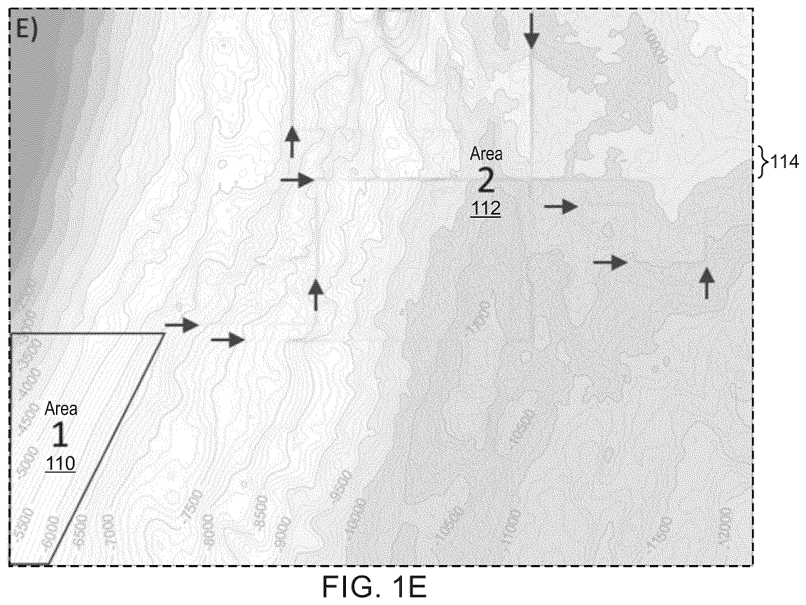

Subsurface mapping projects can be used to combine structural depth map patches that relate to a specific geological layer of interest. This can be done when the map patches do not individually extend over the whole area of interest, but collectively the map patches extend over most or all of the area of interest. Such maps may be sourced from different reflection seismic datasets, for example, that are themselves restricted to some portion of the total area of interest. Depth map patches may or may not overlap in map view, e.g., in a display of maps. In the case when the map patches do not overlap and are completely isolated from one another by gaps in map view, the map patches can be combined using a regridding operation, e.g., using available tools and workflows that are well-established in the industry. The techniques of the present disclosure can be used to solve situations in which one or more map patches overlap with one another. In such cases, it is common that the map patches to not match in depth in the area of overlap (a condition termed a “mistie”). This can occur due to differences in the data acquisition, processing, and interpretation workflows associated with each patch. As an example, different reflection seismic surveys may use different seismic velocity models. If map patches that overlap but mistie are combined using current techniques, linear edge artifacts (see FIG. 1E) can be introduced into the combined map, which can hinder proper evaluation of the combined map. A solution to this problem can include coding an automated algorithm that follows. The grids of each patch can be prioritized in relation to structural information content. This prioritization guides which patches are dominant in the combination process, for example, the most information-rich patch can be selected to be the dominant patch. Next, polygons can be automatically defined in the areas of patch overlap. The polygons can then be grown spatially by a specified amount to ensure a smooth patch combination. The polygons can then be used to delete the enclosed area of lower priority patch in each overlapping area. The resulting patches can be brought to a state of being separated by gaps that are suitable for the final steps automated algorithm, which can use current technologies to produce the combined grid. In this way, the combined grid can inherit the information of the patches in order of information density, as well as producing a continuous overall map without producing edge effects. In some implementations, the combined grid inherits the information of the patches in order of a user-specified information density or some other information characteristic that can be used for prioritization. During the process of generating the combined grid, patches can be transformed into a single working coordinate reference system, such as in a preprocessing step, as is normal for any multiple-dataset mapping activity. For example, the units of measurement used for the patches can be made consistent. A reason for doing this, for example, is that it would not be correct to merge a patch where depth is measured in feet with a patch where depth is measured in meters. One or other of the patches can be corrected using a multiplier or some other conversion technique to ensure that the units are consistent.

In some implementations, metadata can be provided (or generated in a preprocessing step) that describes each patch's resolution, size, and generation attributes. Existing techniques, e.g., as implemented in widely-used mapping applications, can be used to determine dataset characteristics such as grid spacing, amount of smoothing, and so on. However, use of such parameters to characterize and then rank patches is central to the present disclosure. A patch characterization engine, which can analyze each patch against the various criteria, can be implemented as an additional feature of the present disclosure. In some implementations, smoothing stops based on the effect of smoothing in relation to grid spacing in the dataset that is being smoothed, e.g., stopping after a threshold percentage of change in the smoothed data.

An area of interest for subsurface mapping can be defined based on knowledge of a possible extent of a resource, or by knowing an area that may be allocated by an external entity that controls exploration acreage or some subset of it. Subsurface maps can be made from remote sensed data such as reflection seismic, either two-dimensional (2D) or three-dimensional (3D). Subsurface maps can be made using information from wells, which may be evenly spaced in a map view or may be clustered. It is often the case that such datasets do not coincide with an area of interest for a given project. Different types and sources of map data can result in the existence of map “patches” that are combined into a single map that extends continuously over the area of interest. Therefore, in order to make a continuous map that represents the subsurface depth of a geological layer over the entire area of interest, subsets of the entire area of interest (corresponding to available datasets) are mapped individually then combined to generate a continuous depth map (also known as a “structural map”). These map sub-areas can be termed as “patches.” If each patch has been mapped on the same geological layer that is itself continuous across the area of interest, then it is a valid objective to combine the patches into a single map over the whole area of interest. In this case, the single map can then be used for a holistic approach to subsurface characterization, e.g., identifying sites of interest that exist at the boundaries of one or more patches. In another example, sites from different patch areas can be ranked in relation to each other using a common criteria such as area or volume. However, map patches may or may not overlap in map view. The non-overlapping case can occur, for example, in situations in which the map patches do not overlap and are completely isolated from one another by gaps in map view. In this case, the map patches can be combined using a regridding operation, e.g., using available tools and workflows that are well established in the industry.

The present disclosure resolves a case in which two or more map patches overlap with one another. In this case, it is common that the map patches do not match in depth in the area of overlap (creating a “mistie” situation). This can occur due to differences in the data acquisition, processing, and interpretation workflows associated with each patch. For instance, different reflection seismic surveys might have used different seismic velocity models. If map patches that overlap but mistie are combined using available techniques, linear edge artifacts are typically introduced into the combined map, which can hinder the proper evaluation of the combined map.

FIGS. 1A-1D show patches associated with an area of interest 100, according to some implementations of the present disclosure. The patches in FIGS. 1A-1D are independently obtained from different types and sources of map data. Patches can be derived from any one of, or combinations of, 2D reflection seismic surveys, 3D reflection seismic surveys, potential field data (such as gravity and/or magnetic), and deep wells. The area of interest 100 refers to an area of a geological formation defined by commercial criteria such as awarded or available acreage for exploration such as resulting from a mapping of 3D reflection seismic data. In FIG. 1A, a North patch 102 represents seismic data captured within the area of interest 100 using a first seismic data capture technique. For example, the patch could have been generated by any of the previously described techniques. In the main example of the present disclosure, patches were generated from 3D reflection seismic surveys. Each patch represents a different survey. Note that patches can also arise from different subsets of a single source of information, e.g., a single 3D reflection seismic survey of which geographically-separate or overlapping subsets are interpreted by different people at different points in time to yield different patches. In FIG. 1B, an East patch 104 represents seismic data captured within the area of interest 100 using a different generation technique. In FIG. 1C, a South patch 106 represents seismic data captured within the area of interest 100 using a different generation technique. In some embodiments, each of the North patch 102, the East patch 104, and the South patch 106, are generated from separate datasets. For each respective patch, a bounding rectangular box 100 represents an area of interest and is fixed throughout the example given by FIGS. 1A-1E. FIG. 1D shows the map patches 102, 104, and 106, superimposed with polygons identifying the patch boundaries. FIG. 1D also shows gaps at areas 110 and 114, and the boundaries of each respective patch are shown by lines 108. In examples, the patches are superimposed by anchoring patches in place based on spatial grid reference points that mark the location the specific piece of data. As such, in combining patches, there is no scope for lateral movement of information, only vertical.

FIG. 1E shows a combination of the patches 102, 104, and 106 with gaps filled in, according to some implementations of the present disclosure. In FIG. 1E, there are linear artifacts (“misties”) occurring in the composited grid where the patches overlap and a gridding algorithm has been forced to step from one patch to another. In this example, the combination of the patches shown in FIG. 1E includes artifacts that result due to conventional techniques used to combine the patches. Linear artifacts can occur where an overlapping patch does not match the patch that is being overlapped throughout the area of overlap. The match referred to here involves vertical depth, though the issue is the same for any other kind of information, and the present disclosure would work equally well regardless of the kind of information at hand (e.g., potential field data), as long as the information were of the same type and units of measurement in each patch. Area (1) 110 in FIG. 1E defines a region in which a gap between the patches is filled in, where the area (1) 110 in FIG. 1E corresponds to the area (1) 110 of FIG. 1D. In this case, the region includes an area south of (or below) North patch 102 and to the west (or left) of South patch 106. In FIG. 1E, Area 2 112 has many linear “edge” artifacts (indicated by arrows 114) at the locations of grid boundaries 108 of FIG. 1D that do not match each other in depth (e.g., misties).

Techniques of the present disclosure correct misties by smoothly combining overlapping mistied structural depth grids. The techniques can be implemented, for example, as application code, such as to code an automated algorithm for combining overlapping patches. Such algorithms can eliminate the need for time-consuming manual interventions in the mapmaking process, by incorporating an information-driven approach for prioritizing high-quality patches.

In some implementations, a user interface can be used for displaying the progress of the process or making a decision on intermediate or final results. The user interface can present displays that make it possible for the user to see a visual appraisal of the situation, such as the patches depicted in FIGS. 1A-1E. In this way, the user can better understand the layout of patches and overlaps, as well as allowing for a visual appraisal of information content.

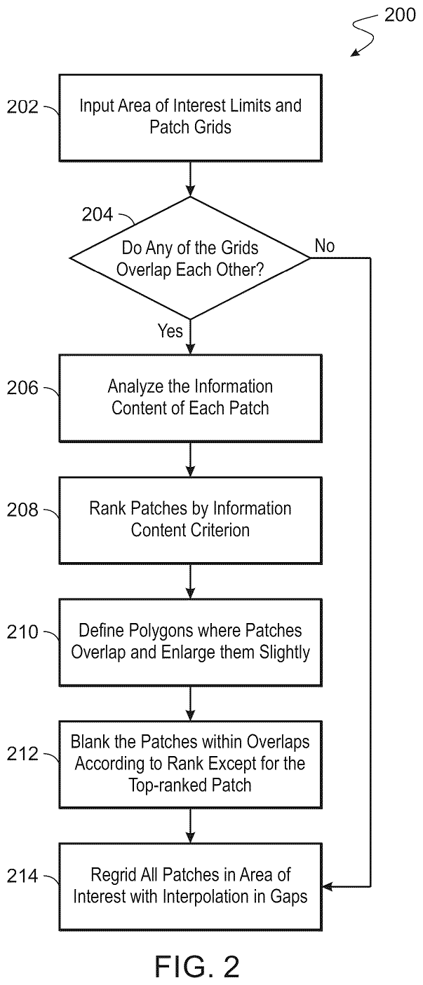

FIG. 2 is a flow chart showing an example of a workflow 200 for combining overlapping mistied structural depth grids, according to some implementations of the present disclosure. In examples, each patch includes structural data associated with an area of interest. The workflow 200 is used, for example, to combine map patches that overlap but mistie, and complete the combining of mistied patches without producing edge effects. The present techniques strategically combine overlapping patches to obtain a smooth and continuous representation of an area of interest.

At 202, an area of interest (AOI) and patch grids are input, e.g., by a user using a user interface. For example, the AOI can be defined and available maps can be gathered for incorporation into a single project. The AOI can be defined by higher-level project constraints. The spatial limits of the AOI can be defined in a coordinate reference system (CRS). In some implementations, the AOI can be defined as a rectangular area with sides aligned with the CRS, e.g., to define north-south and east-west margins of the AOI. In some implementations, an AOI can be defined using other shapes and polygons, in any orientation. The map patches can be imported, e.g., from seismic interpretation software, such as mapping software that grids well information, or any other mapping source so as to retain the sampling density and depth information in each patch. If the patches are originally defined in different CRSs to that used in the project for combining the patches, any such patches can be regridded into the project CRS. Otherwise, further gridding options that compare and combine the patches may be precluded. Units of measurement can also be made consistent between patches at this stage. For example, all depth values can be made in feet, and a consistent convention can be used for positive and negative values relative to a datum (e.g., all values deeper than a threshold datum, such as mean sea level, can be assigned to be negative).

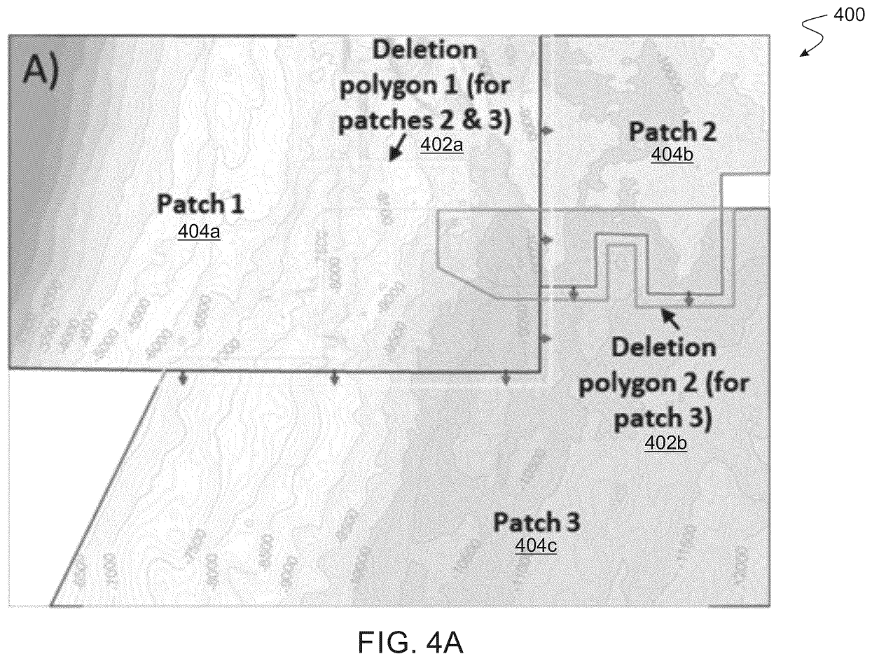

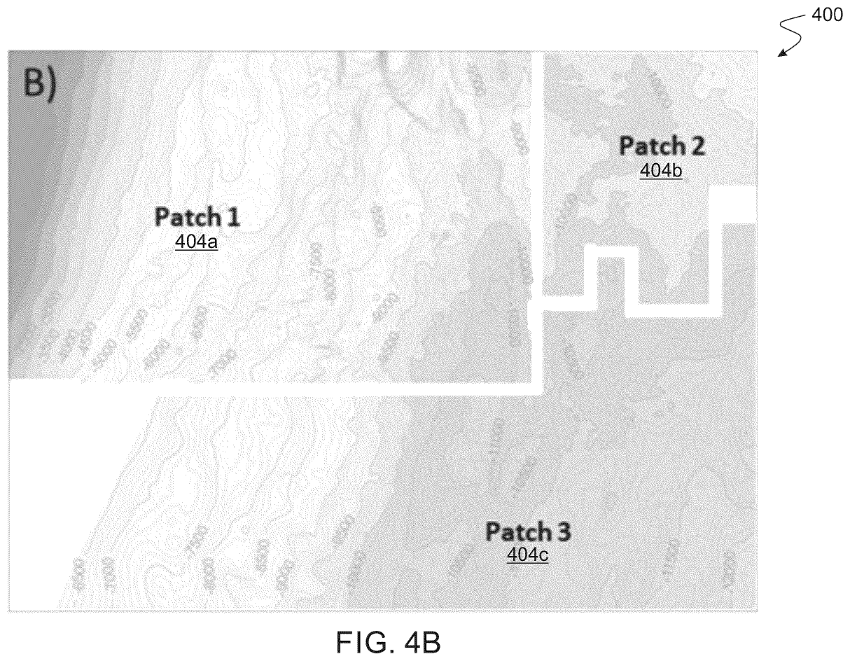

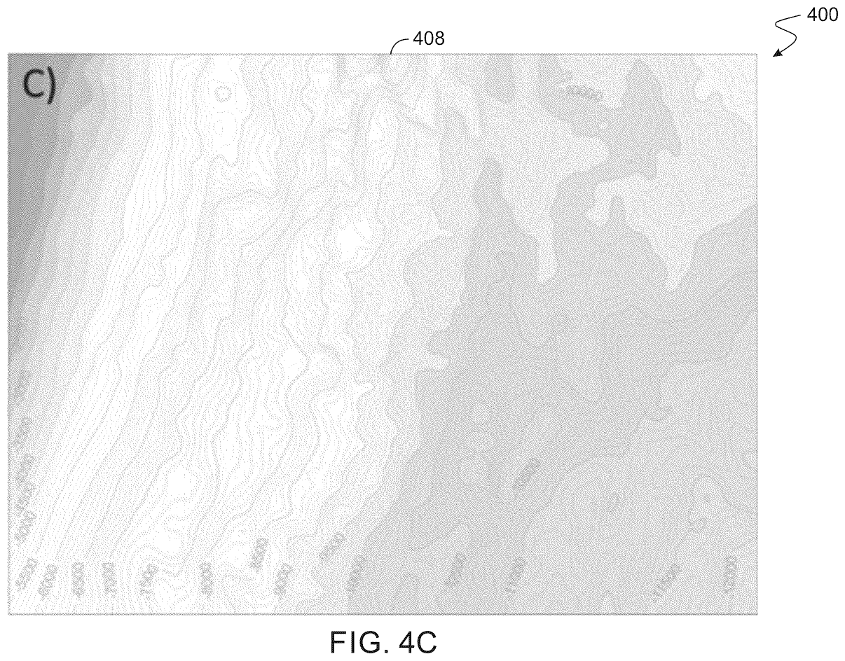

At 204, the patches are assessed for overlap, e.g., to determine whether any of the grids overlap each other. In some implementations, this can be codified by generating spatial polygons around non-null depth data points in each map patch, then comparing the polygons for overlap (e.g., intersecting polygon boundaries, as shown in FIG. 1D). The spatial shapes that are used to evaluate patch boundaries for matching points include, for example, rectilinear or complex polygons, or convex hulls. Overlap is not a prerequisite and can be zero. For example, there could be a gap between patches, meaning that there is no overlap. In the case that a gap exists, the workflow (e.g., workflow 200) or algorithm can jump directly to an interpolation or regridding step. Relative information content of different patches can nonetheless be used to inform the gridding parameters used to produce the combined map. In the event that none of the map patches overlap with any other patches and they are fully separated from one another by spatial gaps, the re-gridding of patches into a new grid over the whole AOI can proceed, e.g., by using available techniques. In some implementations, minimum gap criteria can be used to mitigate edge effects arising from combining two nearly touching patches that mistie each other. The minimum gap criteria can be used, for example, to handle the case in which two nearly, but not quite, overlapping patches are to be subject to local deletion to enlarge the gap to allow for a smooth final product based on both patches. In some implementations, the minimum gap can be manually specified or based on the grid characteristics (e.g., grid node spacing) or based on the edge potential as described with reference to FIGS. 4A-4C.

At 206, the information content of each patch is analyzed. A general expectation is that map patches derived from different sources will not match one another in areas of overlap, in spite of those maps having been prepared to describe the same subsurface geological layer, because the data on which the map patches are based usually arise from remote-sensed data (e.g. reflection seismic data) which is subject to many assumptions and estimates in its preparation. Different source data sets, such as different reflection seismic surveys, typically do not share the same acquisition and processing sequence, which leads to a strong likelihood of misties in areas where the surveys and corresponding derived map patches overlap. The existence of misties in areas of overlap prevents a combined map generation process from simply gridding available data regardless of source, because there will be edge artifacts at the margin of the overlap areas, and/or average depth values produced within the overlap areas that correspond to neither input patch. These artifacts are shown in FIG. 1E, which shows the case of edge artifacts being output where one patch is chosen to have priority over another. In some cases, an algorithm can alternatively compute average values from each patch, at corresponding spatial locations in areas of overlap (not shown in FIG. 1E), which can lead to irregular, noisy zones in areas of overlap. The present techniques prioritize the map patches that take precedence in the re-gridding operation based upon specified criteria such as information characteristics and delete underlying overlapping patches accordingly.

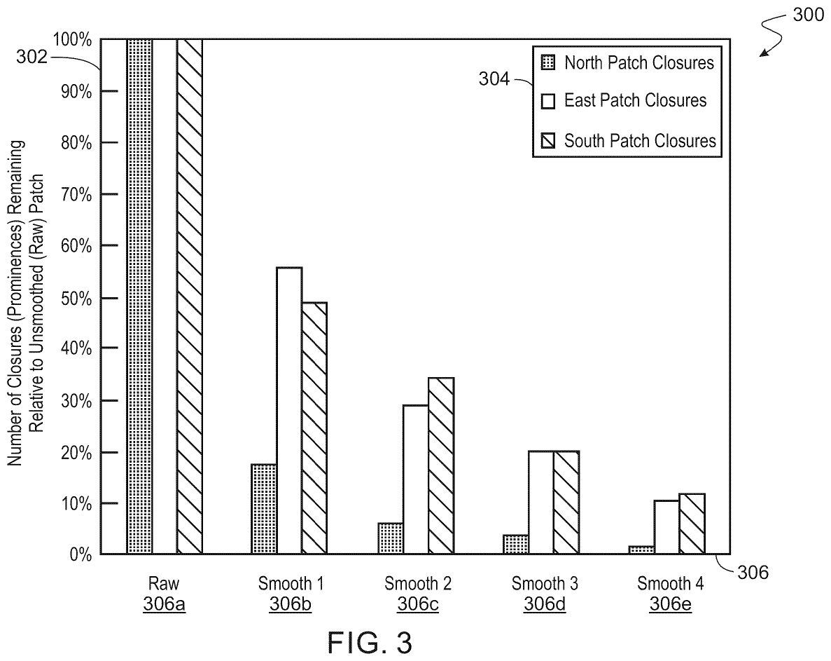

At 208, patches are ranked using information content criteria. The information content criteria includes, for each patch of the mistied grid patches, one or more of prior knowledge and assumptions regarding a quality of seismic velocity model, a vintage of seismic data, acquisition information, and processing parameters. In some implementations, the decision can be driven by assessing the quality of the map patch. The map patch of the highest quality can then be designated as the top-ranked patch, taking precedence over the other patches. Some of the information in the patches may be signal and may correspond to something physically real or that which is being sought, and some of the information may be noise which may be a physical or non-physical artifact. Existing systems that can be applied to quantifying structural information content in map patches include, for example, surface roughness as employed in geomorphological analysis of terrain. For example, such systems can include multiscale structures isolated by Fourier transforms, e.g., using contour tortuosity as a function of smoothing, or by using structural prominence distribution as a function of smoothing (FIG. 3).

In some implementations, the “real information” can include signal to noise content. For example, scale-dependent information content can be considered. The shortest length-scale information that can be contained in a grid can be determined by Nyquist criterion. Information just above this wavelength can be extracted by Fourier analysis or residual from structural smoothing, and then analyzed for randomness (e.g., using orientation characteristics). Length-scale analysis of this nature can yield groups of real (or non-random) versus not real (or random) information. How this knowledge is used to rank patches can be at a user's discretion. For example, the user may decide to prioritize the patch with the highest amount of information content, whether that information is real or not, with a view to post-processing analysis that is outside the scope of the present disclosure.

Patches can be ranked on any suitable criteria. For example, patches can be ranked based on some prior knowledge or assumption such as quality of seismic velocity model, vintage of seismic data, acquisition, processing parameters, and so on. Or, as previously described, the patches can be compared for information content that can be parameterized in a consistent way on each patch, enabling effective comparison in line with the technical requirements of the workflow (e.g., workflow 200).

In some implementations, a commercial or even aesthetic reason can exist for setting a patch priority in a different order from that yielded by objective analysis of information content. For example, a given patch may contain mapping that underpins an established project (e.g., a producing oilfield) in an area that is overlapped by a patch arising from more recent mapping. It may be desirable to retain the older mapping that underpins the oilfield project because changing the map of the oil field or its environs could have far-reaching and unforeseeable implications if the new map was significantly different in the oilfield area. Therefore, the patch containing the original oilfield mapping may be prioritized on a pragmatic basis.

FIG. 3 is a graph 300 which provides an information content comparison of map patches, according to some implementations of the present disclosure. Information presented in the graph 300 includes a number of structural prominences 302 (closures) per patch 304 as a function of smoothing steps 306. The graph 300 presents, for each smoothing step 306, three bars, one bar each for the patches 304 (e.g., North, East, and South patch closures). In the graph 300, the smoothing steps 306 and the corresponding amount of smoothing increases from smoothing steps 1-4 (indicated by graph elements 306b to 306e) relative to an original patch (raw data 306a). Patches 304 are named according to the patches 102, 104, and 106 in the examples described with reference to FIG. 1D. The graph 300 shows that the North patch has sharper drop in information with smoothing, indicating a relatively high density of short-wavelength information relative to East and South patches. This example considers the total amount of information, which may be the desired criterion, but does not distinguish between real and artifact information.

Although the structural prominence option is illustrated in FIG. 3, this is not intended to imply that this is the only (or the best) option by which to determine relative information content between map patches, as FIG. 3 is only an example. Nonetheless, the comparison of structural prominences (closures) in FIG. 3 reveals that, in this example, the North patch has a much sharper reduction in number of closures with smoothing than the other patches, indicating a greater amount of short wavelength information. If the amount of short wavelength information in a map is taken to be a measure of quality, analogous to resolution in a visual image, then in this case the North patch would be assigned precedence over the other two patches. The other two patches in this example happen to have broadly similar information content. In this example, North patch is assigned priority 1, East patch priority 2, and South patch priority 3. Regardless of which method of information analysis is implemented, there should be awareness of whether short wavelength information represents a true signal as opposed to noise in terms of the project objectives. Any noise that is apparent from visual inspection of the input patches can be accommodated by tuning the parameters that compare information content, such as the decay in closure information with scale (i.e. smoothing) shown in FIG. 3.

Referring again to FIG. 2, at 210, polygons are defined in which patches overlap, and patches are enlarged slightly, as needed. Steps 210-214 are described with reference to FIGS. 4A-4C, described below. In this case, polygons are defined that will constrain areas of deletion of the lower-priority grid or grids in each area of overlap. Overlap polygons 402a and 402b are established by the intersections and overlaps of data extent polygons and their definition shown in FIG. 4A. Once defined, the overlap polygons can be grown by a specified distance in order to ensure continuous gaps between the patches. The distance can be specified manually or as a function of mistie between the patches (FIG. 4A).

At 212, patches within an overlap are blanked according to rank, except for the top-ranked patches. In an example, Patch 1 404a has a highest rank, Patch 2 404b has a second highest rank, and Patch 3 404c has a lowest rank. Patches are iteratively evaluated in an order from highest rank to lowest rank. For each patch, areas that overlap with lower ranked patches are determined. Blank or null values are assigned to the determined overlapping areas of subordinate (lower-ranked) patches within the polygons (e.g., the overlap polygons corresponding to each respective patch). The blanking of overlapping areas is done sequentially, for example, so that an overlap polygon defined in relation to the top-priority patch (patch 1 404a in this case) is used to blank patches by determining areas that overlap with overlap polygon of patch 1, e.g., patches 2 404b and 3 404c (indicated by deletion polygon 402a). In turn, an overlap polygon defined in relation to the next-highest priority patch, patch 2 404b in this case (indicated by deletion polygon 402b) is used to blank lesser priority patch or patches (patch 404c 3 in this case). This leads to a set of non-overlapping patches that preserve the maximum amount of structural information from the original patches (FIG. 4B). As shown in FIG. 4B, iterative blanking results in patches that are non-overlapping and do not share borders.

At 214, patches in the AOI are re-gridded, including using interpolation in gaps. In examples, a new grid is created over the AOI using the patches that have been iteratively blanked using overlap polygons as described above. In examples, the composite grid is tied to well depth control and final smoothing is applied, leading to the final product composite depth map (FIG. 4C). Gridding algorithms include, for example, convergent gridding, which populates gaps and blank areas with interpolated and extrapolated points based on nearest available patch data. Alternatives to convergent gridding can include, for example, kriging, minimum curvature, and trend surface. The resulting map (FIG. 4C) is free from edge artifacts. In this step, for example, well depth control refers to identified locations where deep drilled wells intersect the geological layer represented by the patches. Well control may have been used in the initial patch mapping, but this is not necessarily the case, since a given patch may have been on file prior to a new deep well being drilled. In such a case, a pass of assessing a composite grid relative to all relevant well piercing points is desirable to ensure the composited map is accurate in relation to well data, well data being the only “hard” control points.

FIGS. 4A-4C collectively show an example of an implementation of prioritized overlap deletion and final regridding 400, according to some implementations of the present disclosure. Referring to FIG. 4A, deletion polygons 402a and 402b define overlap zones of patches 404a-404c. Overlap bounding polygons can be spatially grown by a specified amount (arrows 406) to ensure enough of a gap to avoid edge effects during the compositing gridding operation. Referring to FIG. 4B, patches 402a-402c are shown after trimming using the overlap polygons shown in FIG. 4A. Patch 2 402b and 3 402c are trimmed. Patch 1 402a, which takes precedence over the other two patches, is untrimmed. Referring to FIG. 4C, a final composited gridded surface 408 free from edge effects is produced. The final composited gridded surface 408 can be compared to the composited gridded surface of FIG. 1E.

The techniques of the present disclosure can inherently produce a continuous gap, assuming that the spatial growth is not zero. This is because the polygons defined on higher-priority patches are used to delete data from the lower priority patches within a given polygon. If zero polygon growth is specified in an overlapping patch scenario, there will be an edge or step between adjoining patches, but no overlap. The growth area can be specified to ensure that any edges associated with patches that do not smoothly trend into one another are turned into smooth ramps during the interpolation and regridding process. The value of growth itself can be defined manually, based on the aesthetic of initial and subsequent products of the workflow. Alternatively, the value of growth can be automated based on an assessment of edge magnitudes between patches and a prescribed minimum edge effect in the final product. The prominence of edges can be quantified by various criteria including map-view curvature and structural inclination trends that parallel the original patch boundaries.

In some implementations, edge detection techniques can be run on the composited grid to compare any edges found with the location and trend of the original patch margins. Any edges that are found can trigger iterative smoothing passes and further edge detection, e.g., until there are no longer edges in the combined map product at the locations that follow the trends of the margins of the original patches. Alternatively, found edges that are parallel and collocated with patch boundaries can trigger a loop in the workflow back to the overlapping polygons stage (step 212) with a larger magnitude of spatial growth than used in the previous iteration.

Composited maps produced using techniques of the present disclosure are most likely to be used in larger-scale projects than drilling individual wells. The uses can include, for example, the assessment of large areas of geological basins for resource distribution such as hydrocarbon traps or sites for carbon dioxide (CO₂) sequestration or subsurface management of other fluids. The techniques of the present disclosure are scalable and can also be used in smaller areas of interest.

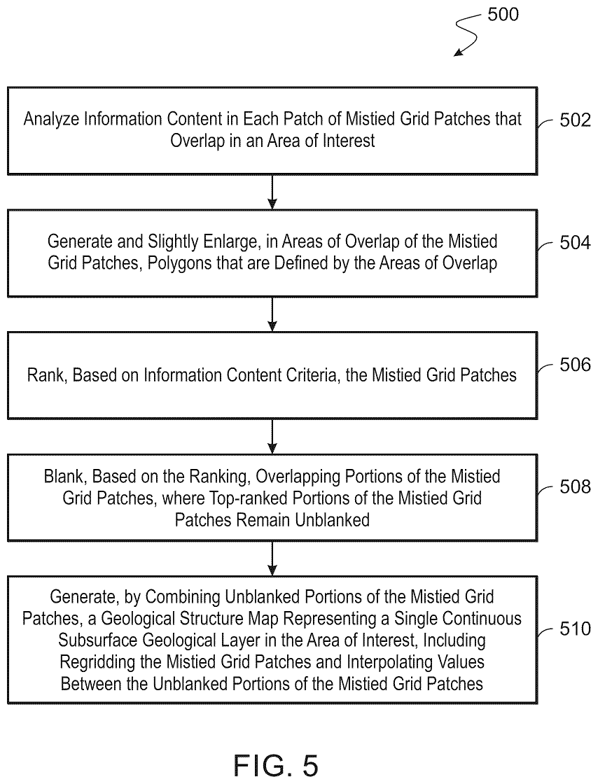

FIG. 5 is a flowchart showing an example of a method 500 for combining mistied grid patches to generate a geological depth or structure map representing a single continuous subsurface geological layer in a given area of interest, according to some implementations of the present disclosure. For clarity of presentation, the description that follows generally describes method 500 in the context of the other figures in this description. However, it will be understood that method 500 can be performed, for example, by any suitable system, environment, software, and hardware, or a combination of systems, environments, software, and hardware, as appropriate. In some implementations, various steps of method 500 can be run in parallel, in combination, in loops, or in other orders, as long as the sequence of ranking, blanking, and regridding is preserved.

At 502, information content is analyzed for each patch of mistied grid patches that overlap in an area of interest. For example, information content associated with map patches 102, 104, and 106 can be analyzed as described with reference to FIG. 2 (e.g., regarding step 206). In some implementations, information content criteria can include, for each patch of the mistied grid patches, one or more of prior knowledge and assumptions regarding a quality of seismic velocity model, a vintage of seismic data, acquisition information, and processing parameters. The analysis includes assessing the map information derived from the seismic data in the patches that will be combined, since it is that map content that is being composited. In addition to, or instead of, characteristics of the data from which map patches are derived (e.g., seismic, wells, potential fields, etc.), information characteristics can be derived from the patch maps themselves. The information characteristics can include, for example, multiscale structure characteristics, a presence of trends that are likely to be of interest, or more subjective aesthetic criteria that result from manual assessment and ranking.

In some implementations, user input can be received (e.g., in a graphical user interface, or GUI) that defines limits of the area of interest, e.g., the coordinates or other geographical definition of the area of interest 100. In some implementations, user input can be received (e.g., in the GUI) that defines the information content criteria (e.g., parameters that identify the content of patches to be combined).

In some implementations, coordinate systems of the mistied grid patches can be transformed into a single working coordinate reference system, such as using a coordinate re-mapping system from one projection to another to account for differences in units and conventions. From 502, method 500 proceeds to 504.

At 504, polygons that are defined by areas of overlap of the mistied grid patches are generated and slightly enlarged in the areas of overlap. For example, the deletion polygons 402a and 402b can be generated as described with reference to FIG. 2 (e.g., regarding step 210). Deletion polygon 1 402a is slightly larger than the overlap between Patch 1 404a and the combination of Patch 2 404b and Patch 3 404c. Deletion polygon 2 402b is slightly larger than the overlap between Patch 2 404b and Patch 3 404c. From 504, method 500 proceeds to 506.

At 506, the mistied grid patches are ranked based on information content criteria. In an example, as described with reference to FIG. 2 (e.g., regarding step 212), Patch 1 404a has a highest rank, Patch 2 404b has a second-highest rank, and Patch 3 404c has a lowest rank.

In some implementations, metadata can be generated that describes, for each mistied grid patch, a resolution, a size, and generation attributes. The mistied grid patches can then be ranked using the metadata. The ranking can be completed using various criteria, e.g., multiscale structure characteristics, the presence of trends that are likely to be of interest, or more subjective aesthetic criteria that result from manual assessment and ranking. From 506, method 500 proceeds to 508.

At 508, overlapping portions of the mistied grid patches are blanked based on the ranking, where top-ranked portions of the mistied grid patches remain unblanked. For example, as shown in FIG. 4B, highest-ranked Patch 1 404a contains the entire region defined by North patch 102. Also, second highest-ranked Patch 2 404b (corresponding to East patch 104) is reduced in area by the overlapping portion of North patch 102. Additionally, lowest-ranked Patch 3 404c (corresponding to South patch 106) is reduced in area based on overlapping portions of North patch 102 and East patch 104. From 508, method 500 proceeds to 510.

At 510, a geological structure map representing a single continuous subsurface geological layer in the area of interest is generated by combining unblanked portions of the mistied grid patches. Generating the geological structure map includes regridding the mistied grid patches and interpolating values between the unblanked portions of the mistied grid patches. In situations in which no intervening patch exists in a certain direction, values can be extrapolated across gaps between patch boundaries and a boundary of the area of interest. Doing this can achieve a key property of the composited map, in that the composited map is free from edge effects (“misties”) related to overlapping patches upon which the composite map is based.

In some implementations, generating the geological structure map can include growing the unblanked portions of the mistied grid patches using a growth value. The growth value can be automated based on an assessment of edge magnitudes in the vertical direction between the mistied grid patches and a prescribed minimum edge effect (e.g., based on a numeric or other threshold) in a final product of the single continuous subsurface geological layer. In an example, overlapping bounding polygons can be spatially grown by a specified amount (arrows 406) to ensure enough of a gap to avoid edge effects during a compositing gridding operation. While the growth value can be automated, the growth value can be specified manually, or the growth value can be iterated based on the presence or absence of edge effects in the final composited map. After 510, method 500 can stop.

In some implementations, method 500 further includes assessing, using the geological structure map, large areas of geological basins for resource distribution. For example, assessing the large areas of geological basins for resource distribution includes assessing the large areas for hydrocarbon traps and sites for carbon dioxide (CO₂) sequestration and subsurface management of fluids. Method 500 can further include the ability to rank sites (e.g., prospective oil fields) based on size, given that a composited map would be the best available single dataset and would give a view on sites that might exist on overlapping patches but not be apparent on a single patch. Other applications of method 500 can include water resource management, since the geological layer represented on the composite map could be an aquifer containing potable water.

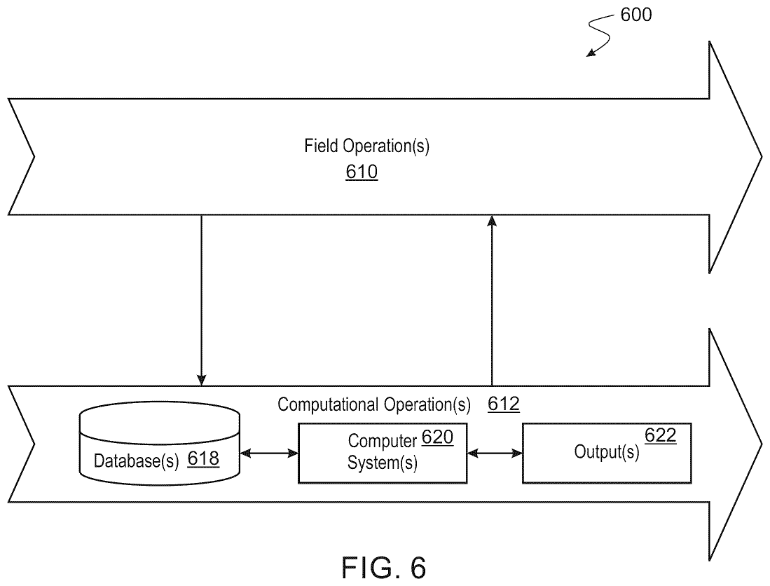

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure can be performed before, during, or in combination with the hydrocarbon production operations 600, specifically, for example, either as field operations 610, computational operations 612, or both.

Examples of field operations 610 include forming/drilling a wellbore, hydraulic fracturing, producing through the wellbore, and injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively, or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth, and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery, and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access and/or interact with the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Described implementations of the subject matter can include one or more embodiments, alone or in combination.

For example, in a first aspect, a computer-implemented method includes the following. Information content is analyzed that is in each patch of mistied grid patches that overlap in an area of interest. Polygons that are defined by areas of overlap of the mistied grid patches are generated and slightly enlarged in the areas of overlap. The mistied grid patches are ranked based on information content criteria. Overlapping portions of the mistied grid patches are blanked based on the ranking, where top-ranked portions of the mistied grid patches remain unblanked. A geological structure map representing a single continuous subsurface geological layer in the area of interest is generated by combining unblanked portions of the mistied grid patches. Generating the geological structure map includes regridding the mistied grid patches and interpolating values between the unblanked portions of the mistied grid patches.

The foregoing and other described implementations can each, optionally, include one or more of the following embodiments:

In a first embodiment, combinable with any of the previous or following embodiments, where the computer-implemented method further includes receiving user input defining limits of the area of interest.

In a second embodiment, combinable with any of the previous or following embodiments, where the computer-implemented method further includes receiving user input defining the information content criteria.

In a third embodiment, combinable with any of the previous or following embodiments, where the information content criteria includes, for each patch of the mistied grid patches, one or more of prior knowledge and assumptions regarding a quality of seismic velocity model, a vintage of seismic data, acquisition information, and processing parameters.

In a fourth embodiment, combinable with any of the previous or following embodiments, where the computer-implemented method further includes transforming the mistied grid patches into a single working coordinate reference system, datums and common units and signage.

In a fifth embodiment, combinable with any of the previous or following embodiments, where the computer-implemented method further includes generating metadata describing, for each mistied grid patches, a resolution, a size, and generation attributes, where the generation attributes include of prior knowledge and assumptions regarding a quality of seismic velocity model, a vintage of seismic data, acquisition information, and processing parameters; and ranking, using the metadata, the mistied grid patches.

In a sixth embodiment, combinable with any of the previous or following embodiments, where generating the geological structure map includes growing the unblanked portions of the mistied grid patches using a growth value that is automated based on an assessment of edge magnitudes between the mistied grid patches and a prescribed minimum edge effect in a final product of the single continuous subsurface geological layer.

In a seventh embodiment, combinable with any of the previous or following embodiments, where the computer-implemented method further includes assessing, using the composited geological structure map, large areas of geological basins for resource distribution.

In an eighth embodiment, combinable with any of the previous or following embodiments, where assessing the large areas of geological basins for resource distribution includes assessing the large areas for hydrocarbon traps and sites for carbon dioxide (CO₂) sequestration and subsurface management of fluids.

In a ninth embodiment, combinable with any of the previous or following embodiments, where generating the geological structure map includes extrapolating values across gaps between patch boundaries and a boundary of the area of interest when no intervening patch exists in that direction.

In a second aspect, a non-transitory, computer-readable medium stores one or more instructions executable by a computer system to perform operations including the following. Information content is analyzed that is in each patch of mistied grid patches that overlap in an area of interest. Polygons that are defined by areas of overlap of the mistied grid patches are generated and slightly enlarged in the areas of overlap. The mistied grid patches are ranked based on information content criteria. Overlapping portions of the mistied grid patches are blanked based on the ranking, where top-ranked portions of the mistied grid patches remain unblanked. A geological structure map representing a single continuous subsurface geological layer in the area of interest is generated by combining unblanked portions of the mistied grid patches. Generating the geological structure map includes regridding the mistied grid patches and interpolating values between the unblanked portions of the mistied grid patches.

The foregoing and other described implementations can each, optionally, include one or more of the following embodiments:

In a first embodiment, combinable with any of the previous or following embodiments, where the operations further include receiving user input defining limits of the area of interest.

In a second embodiment, combinable with any of the previous or following embodiments, where the operations further include receiving user input defining the information content criteria.

In a third embodiment, combinable with any of the previous or following embodiments, where the information content criteria includes, for each patch of the mistied grid patches, one or more of prior knowledge and assumptions regarding a quality of seismic velocity model, a vintage of seismic data, acquisition information, and processing parameters.

In a fourth embodiment, combinable with any of the previous or following embodiments, where the operations further include transforming the mistied grid patches into a single working coordinate reference system, datums and common units and signage.

In a third aspect, a computer-implemented system includes one or more processors and a non-transitory computer-readable storage medium coupled to the one or more processors and storing programming instructions for execution by the one or more processors. The programming instructions instruct the one or more processors to perform operations including the following. Information content is analyzed that is in each patch of mistied grid patches that overlap in an area of interest. Polygons that are defined by areas of overlap of the mistied grid patches are generated and slightly enlarged in the areas of overlap. The mistied grid patches are ranked based on information content criteria. Overlapping portions of the mistied grid patches are blanked based on the ranking, where top-ranked portions of the mistied grid patches remain unblanked. A geological structure map representing a single continuous subsurface geological layer in the area of interest is generated by combining unblanked portions of the mistied grid patches. Generating the geological structure map includes regridding the mistied grid patches and interpolating values between the unblanked portions of the mistied grid patches.

The foregoing and other described implementations can each, optionally, include one or more of the following embodiments:

In a first embodiment, combinable with any of the previous or following embodiments, where the operations further include receiving user input defining limits of the area of interest.

In a second embodiment, combinable with any of the previous or following embodiments, where the operations further include receiving user input defining the information content criteria.

In a third embodiment, combinable with any of the previous or following embodiments, where the information content criteria includes, for each patch of the mistied grid patches, one or more of prior knowledge and assumptions regarding a quality of seismic velocity model, a vintage of seismic data, acquisition information, and processing parameters.

In a fourth embodiment, combinable with any of the previous or following embodiments, where the operations further include transforming the mistied grid patches into a single working coordinate reference system, datums and common units and signage.

What is claimed is:

1. A computer-implemented method, comprising:
analyzing information content in each patch of mistied grid patches that overlap in an area of interest;
generating and slightly enlarging, in areas of overlap of the mistied grid patches, polygons defined by the areas of overlap;
ranking, based on information content criteria, the mistied grid patches;
blanking, based on the ranking, portions of the mistied grid patches, wherein top-ranked portions of the mistied grid patches remain unblanked; and
generating, by combining unblanked portions of the mistied grid patches, a geological structure map representing a single continuous subsurface geological layer in the area of interest, including regridding the mistied grid patches and interpolating values between the unblanked portions of the mistied grid patches.

2. The computer-implemented method of claim 1, further comprising:
receiving user input defining limits of the area of interest.

3. The computer-implemented method of claim 1, further comprising:
receiving user input defining the information content criteria.

4. The computer-implemented method of claim 1, wherein the information content criteria includes, for each patch of the mistied grid patches, one or more of prior knowledge and assumptions regarding a quality of seismic velocity model, a vintage of seismic data, acquisition information, and processing parameters.

5. The computer-implemented method of claim 1, further comprising:
transforming the mistied grid patches into a single working coordinate reference system, datums and common units and signage.

6. The computer-implemented method of claim 1, further comprising:
generating metadata describing, for each mistied grid patches, a resolution, a size, and generation attributes, wherein the generation attributes include of prior knowledge and assumptions regarding a quality of seismic velocity model, a vintage of seismic data, acquisition information, and processing parameters; and
ranking, using the metadata, the mistied grid patches.

7. The computer-implemented method of claim 1, wherein generating the geological structure map includes growing the unblanked portions of the mistied grid patches using a growth value that is automated based on an assessment of edge magnitudes between the mistied grid patches and a prescribed minimum edge effect in a final product of the single continuous subsurface geological layer.

8. The computer-implemented method of claim 1, further comprising:
assessing, using the generated geological structure map, large areas of geological basins for resource distribution.

9. The computer-implemented method of claim 8, wherein assessing the large areas of geological basins for resource distribution includes assessing the large areas for hydrocarbon traps and sites for carbon dioxide (CO₂) sequestration and subsurface management of fluids.

10. The computer-implemented method of claim 1, wherein generating the geological structure map includes extrapolating values across gaps between patch boundaries and a boundary of the area of interest when no intervening patch exists in that direction.

11. A non-transitory, computer-readable medium storing one or more instructions executable by a computer system to perform operations comprising:
analyzing information content in each patch of mistied grid patches that overlap in an area of interest;
generating and slightly enlarging, in areas of overlap of the mistied grid patches, polygons defined by the areas of overlap;
ranking, based on information content criteria, the mistied grid patches;
blanking, based on the ranking, portions of the mistied grid patches, wherein top-ranked portions of the mistied grid patches remain unblanked; and
generating, by combining unblanked portions of the mistied grid patches, a geological structure map representing a single continuous subsurface geological layer in the area of interest, including regridding the mistied grid patches and interpolating values between the unblanked portions of the mistied grid patches.

12. The non-transitory, computer-readable medium of claim 11, the operations further comprising:
receiving user input defining limits of the area of interest.

13. The non-transitory, computer-readable medium of claim 11, the operations further comprising:
receiving user input defining the information content criteria.

14. The non-transitory, computer-readable medium of claim 11, wherein the information content criteria includes, for each patch of the mistied grid patches, one or more of prior knowledge and assumptions regarding a quality of seismic velocity model, a vintage of seismic data, acquisition information, and processing parameters.

15. The non-transitory, computer-readable medium of claim 11, the operations further comprising:
transforming the mistied grid patches into a single working coordinate reference system, datums and common units and signage.

16. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
analyzing information content in each patch of mistied grid patches that overlap in an area of interest;
generating and slightly enlarging, in areas of overlap of the mistied grid patches, polygons defined by the areas of overlap;
ranking, based on information content criteria, the mistied grid patches;
blanking, based on the ranking, portions of the mistied grid patches, wherein top-ranked portions of the mistied grid patches remain unblanked; and
generating, by combining unblanked portions of the mistied grid patches, a geological structure map representing a single continuous subsurface geological layer in the area of interest, including regridding the mistied grid patches and interpolating values between the unblanked portions of the mistied grid patches.

17. The computer-implemented system of claim 16, the operations further comprising:
receiving user input defining limits of the area of interest.

18. The computer-implemented system of claim 16, the operations further comprising:
receiving user input defining the information content criteria.

19. The computer-implemented system of claim 16, wherein the information content criteria includes, for each patch of the mistied grid patches, one or more of prior knowledge and assumptions regarding a quality of seismic velocity model, a vintage of seismic data, acquisition information, and processing parameters.

20. The computer-implemented system of claim 16, the operations further comprising:
transforming the mistied grid patches into a single working coordinate reference system, datums and common units and signage.
